(19) United States
(12) Patent Application Publication
(10) Pub. No.: US 2017/0006332 A1
(43) Pub. Date: Jan. 5, 2017

(54) METHOD FOR RESTITUTION OF AN AVAILABILITY OF AN ITEM OF AUDIOVISUAL CONTENT, AND ASSOCIATED DEVICE, COMPUTER PROGRAM PRODUCT AND DATA MEDIUM

(71) Applicant: THOMSON LICENSING, Issy-les-Moulineaux (FR)

(72) Inventors: Bruno LE GARJAN, Rennes (FR); Gerard CORDA, Rennes (FR); Roland BEASSE, Acigne (FR)

(21) Appl. No.: 15/106,781

(22) PCT Filed: Dec. 17, 2014
(86) PCT No.: PCT/EP2014/078314

§ 371 Date: Jun. 20, 2016

(30) Foreign Application Priority Data
Dec. 24, 2013 (FR) 1363560

(51) Int. Cl. H04N 21/437; H04N 21/472; H04N 21/61

(52) U.S. Cl. CPC H04N 21/437; H04N 21/6112; H04N 21/47202

(57) ABSTRACT

The present disclosure relates to a method for restitution of an availability of an item of audiovisual content in a receiver-decoder device, comprising a reception, from a first network of a first item of information representative of an availability of an item of content broadcast by the first network, via the intermediary of the second network, a restitution of a second item of information representative of the availability of the item of content on the second network, the second item of information depending on the first item of information received.

### 1. FIELD OF THE PRESENT DISCLOSURE

The present disclosure relates to the field of restitution of items of audiovisual content broadcast over a broadcast type network and more specifically to access to an item of content prior or subsequent to its broadcast over this network, via the intermediary of a second network, the location of the item of content via the second network being made possible by the transmission of items of information over the broadcast network.

### 2. PRIOR ART

Many devices for reception and restitution of items of audiovisual content are configured to enable the reception of items of audiovisual content from several networks. Such reception devices are commonly called “hybrid decoders” or “hybrid receivers”. A hybrid receiver thus defined may comprise an interface for connection to a broadcast network and an interface for connection to a broadband network, for example.

A broadcast network is for example an audiovisual content broadcast network similar to the networks used for digital terrestrial television (DTT).

A broadband network is for example a network enabling a local ADSL (Asymmetric Digital Subscriber Line) type connection. An ADSL connection has the advantage of being bidirectional and of making it possible to download items of audiovisual content available on remote servers.

The broadcast (or transmission) of items of audiovisual content over a broadcast network, is most often accompanied by the transmission of items of information representative of the items of content for the purpose of informing the user of the items of content being broadcast and of the items of content which will subsequently be broadcast. This information is notably used for creating electronic programme guides (EPGs). A receiver-decoder device storing these items of information may therefore store a list of items of audiovisual content already broadcast, being broadcast and which will be broadcast in the future.

Receiver-decoders comprising an interface for connection to a broadband network are now currently used for audiovisual content restitution applications, such as video on demand (VOD) or streaming, for example. Among these applications, some are dedicated to the restitution of items of audiovisual content previously broadcast over one or more broadcast type television networks. Thus, for example, servers connected to broadband networks which contain items of content identical to those previously broadcast participate in the implementation of “replay” services. These “replay” services enable the user to find an item of audiovisual content previously broadcast in a catalogue.

The user must nevertheless know of the existence and the location of the accessible “replay” services matching the items of content broadcast over the transmission channels of the broadcast network and any conditions of access to the restitution required for a restitution from a broadband network.

### 3. SUMMARY OF THE INVENTION

The present disclosure makes it possible to improve the prior art by proposing a method for restitution of an availability of at least one item of audiovisual content implemented in a receiver-decoder device comprising a first communication interface adapted to the reception of at least one item of audiovisual content from a first network, and a second communication interface adapted to the reception of at least one item of audiovisual content from a second network.

According to at least one particular embodiment, said method comprises:
a reception, from said first network, of at least one first item of information representative of an availability, via the intermediary of said second network, of at least one item of content broadcast via said first network, said first item of information comprising at least:
a location of said item of content on said second network;
a period of availability of said item of content over said second network, different from the period of broadcast of said item of content over said first network;
a restitution, on a user interface of said receiver-decoder device, of at least one second item of information representative of said availability of said item of content via the intermediary of said second network, said second item of information being dependent on said first item of information received.

According to a particular characteristic, the first network is a unidirectional broadcast network.

According to a particular characteristic, the second network is a bidirectional communication network,

According to a particular characteristic, said reception is implemented prior and/or subsequent to said broadcast of said item of content by said first network.

According to a particular characteristic, said at least one second item of information comprises at least one object for selection of said item of audiovisual content. Such a selection object enables for example a proposal of restitution of said item of content from said second network.

According to a particular characteristic, said restitution method comprises a restitution of all or part of said item of audiovisual content, via the intermediary of said second network.

According to a particular characteristic, said restitution of all or part of said item of audiovisual content is implemented after activation of said selection object.

According to a particular characteristic, said at least one first item of information comprises a precondition, limiting the restitution of said item of content from said second network.

According to a particular characteristic, said restitution of said second representative item of information takes account of said precondition.

According to a particular embodiment, said at least one first item of information representative of the availability of the item of content via the intermediary of the second network comprises a link to a remote server connected to the second network.

According to a particular characteristic, said location comprises at least one link giving access to said item of content on a remote server connected to said second network.

According to a particular embodiment, said at least one first item of information representative of the availability of the item of content via the intermediary of the second network comprises a start date of availability of the item of content via the intermediary of the link to a remote server connected to the second network and/or an end date of availability.

According to a particular embodiment, said at least one first item of information representative of the availability of the item of content via the intermediary of the second network comprises an end date of availability of the item of content via the link to a remote server connected to the second network.

According to a particular characteristic, said at least one first item of information comprises at least one item of information relating to a period of free access to said item of content over said second network with a view to its restitution.

According to a particular characteristic, said at least one first item of information comprises an item of information relating to an association of a related item of content with said item of content, accessible from said second network.

According to a particular embodiment, said at least one first item of information representative of the availability of the item of content via the intermediary of the second network comprises an item of information relating to a cost of access to the item of content via the second network.

According to a particular embodiment, said at least one first item of information representative of the availability of the item of content via the intermediary of the second network comprises an item of information relating to a format and/or a level of quality of restitution of the item of content via the intermediary of the second network.

Although not explicitly described, the embodiments presented can be implemented using any combination or sub-combination. For example, an embodiment wherein said at least one first item of information comprises at least one item of information relating to a period of free access to said item of content over said second network with a view to its restitution can be combined with an embodiment wherein said at least one first item of information comprises an item of information relating to an association of a related item of content with said item of content, accessible from said second network.

Other embodiments, easily conceivable by those skilled in the art on reading the present description, are also included within the scope of the present disclosure.

The present disclosure relates in particular to a method for presentation and selection of an item of audiovisual content, restituting an availability of said item of audiovisual content, with a view to its restitution by a receiver-decoder device prior or subsequent to its transmission over a first network,

the method being implemented in the receiver-decoder device,

the receiver-decoder comprising a first communication interface adapted to the reception of the at least one item of audiovisual content from the first network, and,

a second communication interface adapted to the reception of the at least one item of audiovisual content from a second network,

the first network being a unidirectional broadcast network and the second network being a bidirectional communication network.

According to a particular embodiment, the method comprises:
a reception, from the first network of at least one first item of information representative of an availability of the item of content via the intermediary of the second (bidirectional) network,
a presentation, on a user interface implemented by the receiver-decoder device, of at least one second item of information representative of the availability of the item of content via the intermediary of the second network with a view to a restitution by the receiver-decoder, said second item of information being dependent on said first item of information,
a selection of the item of audiovisual content, via the intermediary of at least one second item of information representative of the availability of the item of content via the intermediary of the second (bidirectional) network,

a restitution of all or part of the item of audiovisual content, via the intermediary of the second network, prior or subsequent to its broadcast via the intermediary of the first network in response to selection by a user.

According to another aspect, the present disclosure relates to a receiver-decoder device adapted to a restitution of an availability of an item of audiovisual content, said receiver-decoder device comprising:
a first communication interface adapted to the reception of at least one item of audiovisual content from a first network, and
a second communication interface adapted to the reception of at least one item of audiovisual content from a second network.

According to at least one particular embodiment, said receiver-decoder device comprises a processor configured for:
a reception, from said first network, of at least one first item of information representative of an availability, via the intermediary of said second network, of at least one item of content broadcast via said first network, said first item of information comprising at least:
   a location of said item of content on said second network;
   a period of availability of said item of content over said second network, different from the period of broadcast of said item of content over said first network;
   a restitution, on a user interface of said receiver-decoder device, of at least one second item of information representative of said availability of said item of content via the intermediary of said second network, said second item of information being dependent on said first item of information received.

Although not explicitly described, said receiver-decoder device can be configured to implement the restitution method in any one of its embodiments.

In particular, the present disclosure also relates to a receiver-decoder device adapted to the restitution of an item of audiovisual content from a first and a second network, the first network being a unidirectional broadcast network and the second network being a bidirectional broadband communication network,

the receiver-decoder comprising:
a module for reception, from the first network, of a first item of information representative of the availability of the item of content from the second network,
a user interface module adapted to the presentation of at least one second item of information representative of the availability of the item of content with a view to a restitution by the receiver-decoder, the second item of information being dependent on the first item of information received,
a module for restitution of all or part of the item of audiovisual content, from the second network and prior or subsequent to its broadcast via the intermediary of the first network, the item of content being selected with a view to its restitution via the intermediary of the second item of information representative of its availability presented on the user interface.

According to a particular embodiment, said at least one first item of information representative of the availability of the item of content via the intermediary of the second network, received by the device from the first network, comprises a link to a remote server connected to the second network.

According to a particular embodiment, said at least one first item of information representative of the availability of the item of content via the intermediary of the second network, received by the device from the first network, comprises a start date of availability of said item of content via said link to a remote server connected to said second network.

According to an embodiment of said device, said at least one first item of information representative of the availability of the item of content via the intermediary of the second network, received by the device from the first network, comprises an end date of availability of said item of content via said link to a remote server connected to said second network.

According to an embodiment of said device, said at least one first item of information representative of the availability of the item of content via the intermediary of said second network comprises an item of information relating to a period of free access to said item of content over said second network with a view to its restitution.

According to yet another aspect, the present disclosure relates to a computer program product comprising program code instructions for executing the above restitution method, in any one of the aforementioned embodiments, when said program is executed by a computer.

According to yet another aspect, the present disclosure relates to a computer-readable storage medium on which is saved a computer program comprising program code instructions for executing the above restitution method, in any one of the aforementioned embodiments, when said program is executed by a computer.

Such a computer-readable storage medium can take the form of a computer program product loaded onto at least one computer-readable storage medium comprising computer-readable and computer-executable program code instructions.

Thus, in the present patent application, a computer-readable storage medium is considered as being a non-transitory storage medium having the intrinsic capacity to store information and the intrinsic capacity to enable a restitution of the items of information which it stores.

A computer-readable storage medium can be for example, but not only, a system, a device or an item of equipment which is electronic, magnetic, optical, electromagnetic or infra-red, made of semiconductors or implements a combination of the techniques previously mentioned. It should be underlined that the following elements, which provide more specific examples of computer-readable storage media to which the principles of the present disclosure can be applied, are essentially mentioned for illustrative purposes and in no case constitute an exhaustive list, as will be easily interpreted by those skilled in the art: a portable computer diskette, a hardware disc, a memory of ROM (Read Only Memory) type, an erasable memory of EPROM (Erasable Programmable Read Only Memory) type or flash memory, a portable compact disc comprising a ROM memory (CD ROM), an item of optical storage equipment, an item of magnetic storage equipment, or any suitable combination of the preceding elements.

As would be easily understandable for those skilled in the art, according to variants, the aspects of the present invention can be implemented by an item of equipment, by a method or a computer-readable storage medium. Thus, aspects of the present invention can be implemented in certain embodiments in the form of entirely hardware components (for example an electronic component or an electronic card equipped with components), or in the form of entirely software components (including for example firmware components, a “resident” software program, microcode, etc.). Other embodiments can implement both hardware components and software components. Moreover, these hardware or software components can be implemented in a same physical item of equipment or in different physical items of equipment.

In the present document, the term “module” will generally designate a component which can correspond either to a hardware component or to a software component. Moreover, aspects of the present invention can be implemented in the form of a computer-readable storage medium. Any combination of one or more computer-readable storage media can be used.

The terms “information relating to the availability of an item of content” are understood to mean an item of information characterising one or more conditions for access to an item of audiovisual content via the second network, such as, for example, an availability period (start or end) limit, a free-of-charge availability time, a paid-for availability time, a link making it possible to access one or more formats enabling an improved restitution, an item of information relating to rights required for the restitution on a receiver device (access control), an item of information relating to parental control, an item of information relating to a permission for locally recording the item of content to a receiver device, and more generally any item of information which, associated with a link making it possible to locate the item of content on a remote server, makes it possible to increase the apparent functions of a receiver-decoder device during the restitution of an item of content from a broadband network.

Thus, the restitution via the broadband network is dependent, at the receiver-decoder device, on the “information relating to the availability of an item of content” associated with the link enabling its location via a broadband network.

### 4. LIST OF FIGURES

The present disclosure will be better understood, and other specific features and advantages will emerge upon reading the following description, the description making reference to the annexed drawings wherein:

FIG. 1 shows a hybrid receiver-decoder device connected to a broadcast network and to a bidirectional broadband network implementing a method for restitution of an availability of at least one item of audiovisual content, according to a particular and non-restrictive embodiment.

FIG. 2 shows architectural details of the hybrid content receiver-decoder device which appears in FIG. 1.

FIG. 3 is a diagram showing steps implemented by the hybrid receiver-decoder device visible in FIGS. 1 and 2, implementing the restitution method of the present disclosure, according to a particular and non-restrictive embodiment.

### 5. DETAILED DESCRIPTION OF EMBODIMENTS

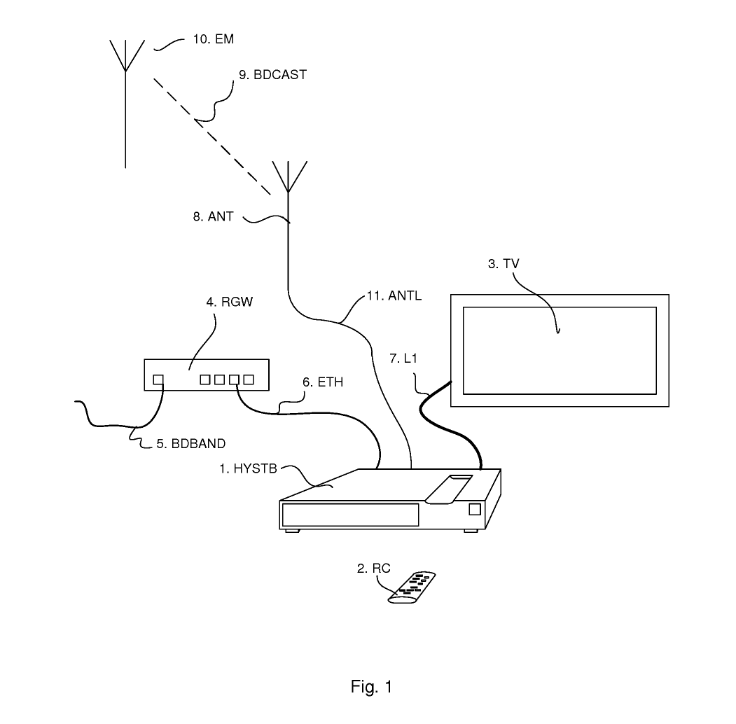

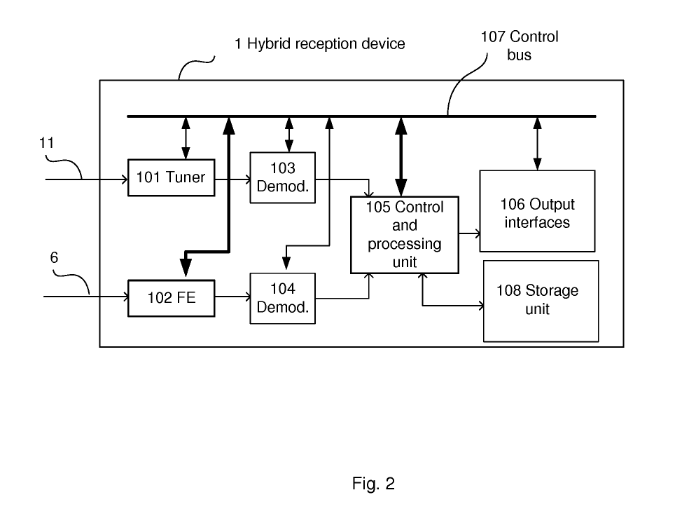

In FIGS. 1 to 2, the modules shown are functional units that may or may not correspond to physically distinguishable units. For example, these modules or some of them are grouped together in a single component, or constituted of functions of the same software. On the contrary, according to other embodiments, some modules are composed of separate physical entities.
FIG. 1 shows a hybrid receiver-decoder device HYSTB 1 comprising an interface for connection to a bidirectional broadband network BDBAND 5 and an interface for connection to a point-to-multipoint unidirectional audiovisual content broadcast network BDCAST 9. The terms “broadcast network” are understood to mean a unidirectional transmission network traditionally called a “broadcast network” by those skilled in the art. It is a network transmitting items of audiovisual content, in the form of data, from a transmitter, to a plurality of receiver devices, similar, for example, to the hybrid receiver-decoder device HYSTB 1.

The hybrid receiver-decoder HYSTB 1 is connected to the bidirectional broadband network BDBAND 5 via the intermediary of a modem-router device RGW 4 and an Ethernet local network link ETH 6. It is also connected to the broadcast network BDCAST 9 via the intermediary of a reception antenna ANT 8. According to the embodiment presented, the broadcast network BDCAST 9 is compatible with a transmission of items of audiovisual content according to the techniques traditionally used for digital terrestrial television (DTT). A link ANTL 11 enables a connection of the DTT reception antenna ANT8 to the hybrid receiver-decoder device HYSTB 1. The hybrid receiver-decoder HYSTB 1 is connected to an audiovisual content restitution device TV 3 via the intermediary of a link L1 7. The device TV 3 is a television set and the link L1 7 is an HDMI (High Definition Multimedia Interface) digital interface, according to a particular and non-restrictive embodiment of the present disclosure. The hybrid receiver-decoder HYSTB 1 can be controlled via the intermediary of control keys located on the front face and not shown in the figure and/or via the intermediary of a remote control device RC 2.

The point-to-multipoint unidirectional broadcast network is represented in the figure by a link BDCAST 9 between a transmitter EM 10 and the reception antenna TNT ANT 8.

The audiovisual content restitution device enables the display, by superimposition of the video or picture-in-picture display, of screens and user interface menus implemented by a control and processing unit of the hybrid receiver-decoder HYSTB 1.

According to the embodiment presented, the transmitter EM 10 broadcasts (transmits) items of audiovisual content (also commonly called audiovisual programmes) over the broadcast network BDCAST 9 and items of information of content descriptor types such as those known by those skilled in the art and presented in EIT data tables of descriptor type. The EITs (event information tables) transmitted in the transmitted data streams serve to indicate, at receivers connected to the network BDCAST 9, the items of content being broadcast or which will soon be broadcast (within a predefined time interval). Thus the content of these EIT data (tables) can be used by the receivers receiving them for the purpose of forming the electronic programme guide applications and the related user interfaces. It is thus possible to obtain items of information such as the titles of the items of audiovisual content being broadcast, their respective types (or categories to which they belong), their respective broadcast start times, their respective broadcast end times and a number of details specific to each of the items of content, such as, as a non-restrictive example, the year of creation, the names of certain individuals who appear in them (actors), the name of the director, and other items of information aiming to provide even more description of the item of content for a user of the hybrid receiver-decoder HYSTB 1. Cleverly, the tables of audiovisual content descriptor type contain extended data, such as for example links making it possible to access the same items of audiovisual content as those broadcast over the broadcast network BDCAST 9 or which will be broadcast over this network in the future, via the intermediary of a bidirectional broadband network, such as, for example, the network BDBAND 5. These extended data further comprise related information indicating conditions of availabilities for a receiver, such as for example, an availability start time, an availability end time, a type of prerequisite right for viewing, a type of encryption, a cost of access and a coding format. These examples are non-restrictive.

The tables of audiovisual content descriptor type thus extended are called “extended EITs” here in order to simplify the reading of the following paragraphs.

According to the embodiment presented, extended EIT tables are transmitted regularly over the broadcast network BDCAST 9, at an average time interval of a few seconds, and comprise items of information relating to the items of content accessible via the broadband network, including, for example:
a link of URL (Unified Resource Locator) type compatible with transfer protocols of HTTP or RSTP type, for example,
a start date of availability of an item of audiovisual content, via the intermediary of a defined link,
an end date of availability of an item of audiovisual content via the intermediary of a defined link,
an item of information on cost of restitution of the programme from a defined link,
one or more bitrates corresponding to one or more version of encoding an item of audiovisual content,
a type of coding or a use or coding standard descriptor for an item of audiovisual content,
one or more items of language and/or subtitling information associated with or comprised in an item of audiovisual content,
an item of information aiming to define whether recording or implementation of advanced functions of “trick mode” type is possible on a receiver device restituting the item of content concerned,
an item of information aiming to defined whether one or more of the related items of content can be associated with the restitution of an item of audiovisual content, these related items of content being, for example, items of advertising or informational content.
one or more secondary links (or secondary addresses) making it possible to access the item of content in the event of failure of access to the item of content via the main link or in the event of unavailability of a server comprising the item of content concerned.
an item of information relating to a filtering of parental control type or control of data received by a receiver,
an item of information describing prerequisite rights for viewing from a server of the broadband network BDBAND 5,
an item of information describing a maximum quality supported at restitution according to the type of receiver used,
an item of information relating to a user profile of users having already accessed the item of content via the intermediary of the broadband network BDBAND 5.

According to the embodiment presented, the audiovisual content receiver-decoder device HYSTB 1 is configured for the reception of all the items of information presented in the extended EIT tables broadcast over the broadcast network HYSTB 1 and for the construction of user interface elements aiming to inform the user of the items of audiovisual content being broadcast or soon to be broadcast over the broadcast network BDCAST 9 and likewise available via the intermediary of the broadband network BDBAND 5. The user interface implemented by the receiver-decoder HYSTB 1 displays, for example, icons, pictograms, thumbnails or titles enabling the user to select an item of content available with a view to its restitution by the audiovisual content restitution device TV 3.

The user interface thus implemented is adapted to presenting the items of content available according to predetermined criteria, automatically or by configuration performed by a user. These criteria are, as an example, a time interval corresponding to a period of availability, a maximum cost inherent in the restitution of an item of content, a type of content (for example films, video clips, musical programme, information, weather, sport, news, etc.).

Thus, the user interface of the receiver-decoder HYSTB 1 implements a representation of an item of content depending on an item of information received in an extended EIT table, the item of information being defined as representative of the availability of the item of content via the broadband network BDBAND 5.

FIG. 2 shows architectural details of the hybrid audiovisual content receiver-decoder device HYSTB 1 according to a particular and non-restrictive embodiment of the present disclosure.

The receiver-decoder device HYSTB 1 is adapted to the restitution of items of audiovisual content received from the bidirectional broadband network BDBAND 5, prior or subsequent to the respective transmission of these same items of content over the broadcast network BDCAST 9.

The network BDCAST 9 is a unidirectional broadcast network and the network BDBAND 5 is a bidirectional broadband communication network. The receiver-decoder HYSTB 1 comprises a communication interface 6, for example an interface of Ethernet type (such as a Fast Ethernet interface) coupled to a demodulator 104, enabling access to items of audiovisual content from the bidirectional broadband network BDBAND 5. The receiver-decoder HYSTB 1 comprises a tuner TNT 101 coupled to a demodulator 103, acting together as a module for reception, from the network BDCAST 9 and via the intermediary of an antenna link ANTL 11 from the reception antenna ANT 8, of items of audiovisual content and of EIT and/or extended EIT tables comprising one or more items of information respectively representative of the availability of the items of audiovisual content via the intermediary of the bidirectional broadband network BDBAND 5. The receiver-decoder device HYSTB 1 comprises a control and processing unit 105. The control and processing unit 105 comprises one or more microcontrollers notably comprising a processor, a non-volatile memory useful for the storage of instructions for embedded executable programs, a volatile random access memory useful for the execution of software routines and for the storage of volatile data, a module for demultiplexing incident data streams, a filtering and demultiplexing module, an audio decoding module, a video decoding module, a module for creating graphic and textual objects, and all the components traditionally used and useful for the proper operation of a control and processing unit, not all of these components being detailed further here, not being necessary to the understanding of the present disclosure. The control and processing unit 105 is configured to operate as a user interface module making it possible to present to a user of the hybrid receiver-decoder HYSTB 1 at least one item of information representative of the availability of an item of content currently being or soon to be broadcast over the broadcast network BDCAST 9 and also available over a remote server connected to the network BDBAND 5. The item of content being able to be downloaded, according to well-known techniques of downloading or streaming with a view to its restitution by the hybrid receiver-decoder HYSTB 1 coupled to the restitution device TV 3. Either keys on the front face of the hybrid receiver-decoder HYSTB 1 or its remote control device RC 2 can be used, coupled to the control and processing unit 105 which executes software routine, to navigate the user interface and operate as a module for selection by a user of the receiver-decoder HYSTB 1 of an item of audiovisual content via the intermediary of items of information representative of the availability of items of content presented to the user. These representative items of information are, for example, pictograms, icons, titles, texts, or links of URL type, in correlation with the content of the extended EITs, and making it possible when one of them is selected, to access an item of content via the intermediary of the network BDBAND 5, this item of content being moreover in the process of being broadcast, already broadcast or to be broadcast in the future over the broadcast network BDCAST 9.

The extended EITs therefore make it possible, due to their content, to establish links between identical items of content available both over the network BDCAST 9 and over the network BDBAND 5. The availability over the network BDCAST 9 being by definition of shorter duration than that via the network BDBAND 5, as it is limited to the broadcast time.

The control and processing unit 105, coupled to an output interface module, also operates as a module for restitution of all or part of an item of audiovisual content, whether available in reception from the broadcast network BDCAST 9 or downloaded from the broadband network BDBAND 5.

The receiver-decoder HYSTB 1 comprises a storage unit 108, which comprises non-volatile flash memory elements and a storage unit of hard disc type, useful for the implementation of recording or trick-mode functions well-known by those skilled in the art (fast forward, freeze frame, pause, rewind, etc.)

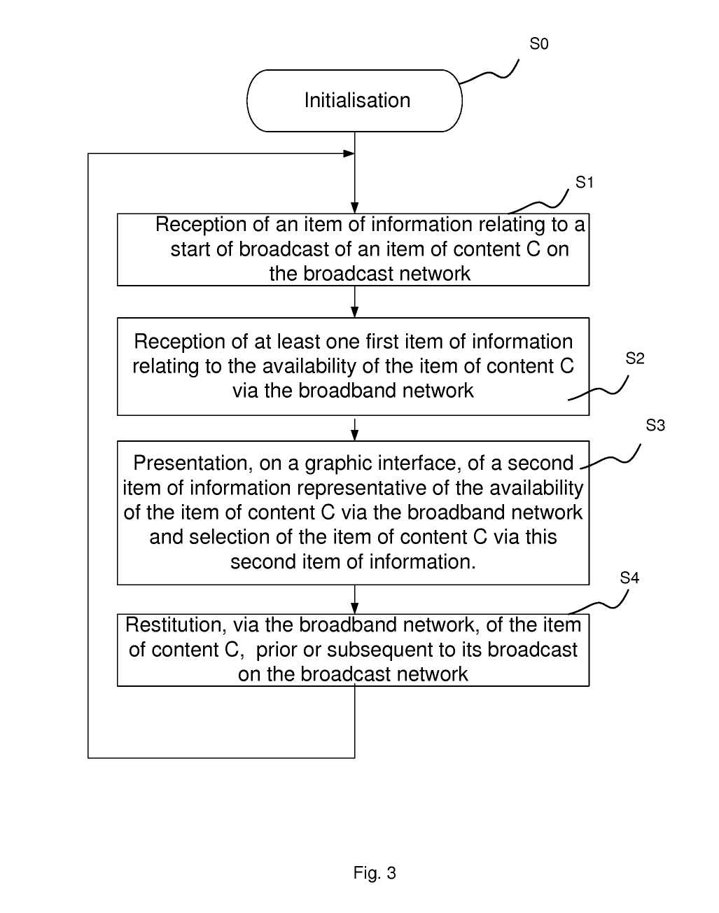

FIG. 3 is a diagram which shows the steps of the restitution method of the present disclosure, according to a particular and non-restrictive embodiment.

Step S0 is a step of initialisation at the end of which the hybrid audiovisual content receiver-decoder is configured in a nominal mode and receives a data stream carrying items of audiovisual content from the broadcast network BDCAST 9. The receiver-decoder carries out a demultiplexing of the incident stream received via the tuner 101 and the demodulator 103 and is configured for the extraction, storage and analysis of the EIT and/or extended EIT information of content descriptor type broadcast over the unidirectional broadcast network BDCAST 9.

In step S1, the hybrid receiver-decoder HYSTB 1 receives, from the transmitter EM10 and via the network BDCAST 9, an item of information relating to the availability of an item of audiovisual content C over the broadcast network BDCAST 9 in a table of EIT type. The table comprises an event descriptor indicating that an item of audiovisual content C, of daily news programme type, whose title is “evening news”, will be broadcast on a channel of the broadcast network BDCAST 9, from 8 p.m., and on the channel entitled “Canal 2”.

In step S2, the hybrid receiver-decoder HYSTB 1 receives, from the transmitter EM10 and via the network BDCAST 9, an item of information relating to the availability of the item of audiovisual content C over the broadband network BDBAND 5 in a table of extended EIT type. The table comprises a descriptor comprising an item of information relating to the availability of the item of audiovisual content C (daily news programme, whose title is “evening news”) from the time 8.30 p.m. and at an address www.bdband.net/CDN1/content/evening_news.html. The extended EIT descriptor table which comprises these items of information further comprises an item of information indicating a cost of 0.50 euros, associated with viewing from this address, payable by the user and invoiced to his subscriber account in accordance with the possession and use of the hybrid receiver-decoder HYSTB 1. All items of information related to the availability of the item of audiovisual content C via the intermediary of the bidirectional network BDBAND 5 are stored in a memory of the control and processing unit 105.

In step S3, the control and processing unit 105 operates so as to add a selection object, for example a pictogram representative of an item of information content on a graphic screen superimposed on the restitution in progress by the hybrid receiver-decoder HYSTB 1 and the restitution device TV3. The pictogram indicates an item of information content and the date of availability of 8.30 p.m. and an indication of cost. A user of the receiver-decoder HYSTB 1 selects this pictogram by using means for navigating the graphic screen which acts as a user interface under control of the control and processing unit 105. The navigation means enable the selection of the pictogram, for example, by a use of the remote control device RC 2 of the hybrid receiver-decoder device HYSTB 1.

Still in step S3, when a user has selected, or in other words activated, the pictogram corresponding to the item of audiovisual content C, broadcast between 8 p.m. and 8.30 p.m. over the broadcast network BDCAST 9 and available from 8.30 p.m., on condition of payment, via the broadband network BDBAND 5, the control unit can perform a restitution by streaming, for example, from the address www.bdband.net/CDN1/content/evening_news.html, from the indicated availability start time. The control and processing unit analyses, if applicable, all items of information useful for the implementation of the streaming session and present in an extended EIT table.

Step S4 corresponds to the implementation of the streaming session subsequent to or starting at the time the item of content is made available at the address www.bdband.net/CDN1/content/evening_news.html, i.e. from 8.30 p.m. on the day of broadcast.

Advantageously, if an item of information representative of the availability of an item of content from the broadband network BDBAND 5, received in an extended EIT table, indicates a precondition for the restitution of the item of content from the broadband network BDBAND 5 by the receiver-decoder device HYSTB1, such as, for example, prior right acquisition, the user interface can forgo displaying the link for selection of the item of audiovisual content from the broadband network BDBAND 5 or can display a selection link (pictogram, icon, title, etc.) showing a limitation or a restriction inherent in the restitution of the item of content from the broadband network BDBAND 5. This representation of a selection link of the user interface constitutes a second item of information representative of availability which is determined according to the first representative item of information received in an extended EIT.

In other words, in the particular embodiment shown, the method for restitution of an availability of the item of audiovisual content C, implemented by the receiver-decoder HYSTB1, comprises:
the reception, from the unidirectional network BDCAST 9, of at least one item of information representative of a start of a broadcast of the item of content C, via the intermediary of the network BDCAST 9, this item of information being comprised in one or more information fields of a content descriptor, such as, for example, an EIT table,
the reception, from the unidirectional network BDCAST 9, of at least one first item of information representative of an availability of the same item of content C via the intermediary of the bidirectional broadband network BDBAND 5, this item of information being comprised in one or more information fields of a content descriptor, such as, for example, an EIT table and/or an extended EIT table,
a restitution, on the user interface implemented by the control and processing unit 105 of the receiver-decoder device HYSTB 1, of at least one second item of information representative of the availability of the item of content via the bidirectional broadband network BDBAND5, for example on a remote server connected to this network, with a view to a restitution by the receiver-decoder HYSTB 1, coupled to the restitution device TV 3,
a proposal of the item of audiovisual content C thus represented by the user interface, via the intermediary (for example via at least one selection object) of at least this second item of information representative of the availability of the item of content C, comprising for example a pictogram, an icon, a title, a tab, or a symbol.
a restitution, by the receiver-decoder device HYSTB 1, of all or part of the item of audiovisual content C, received via the network BDBAND 5, prior or subsequent to its broadcast via the intermediary of the network BDCAST 9, in response to selection by a user, via the graphic interface (user interface), for example by the activation of a selection object.

According to a particular embodiment, said at least one first item of information representative of the availability of the item of content C via the intermediary of the broadband network BDBAND 5, in a descriptor of EIT and/or extended EIT type, comprises an item of information relating to a period of free access to said item of content with a view to its restitution, an item of information relating to said item of content being made available, and an item of information relating to the end of availability of the item of content C by this means. For example, the descriptor indicates, by the use of appropriate information fields, that the item of content C is a “daily news programme”, available at the address www.bdband.net/CDN1/content/evening_news.html at the price of 0.50 euros from 8.30 p.m. for 5 days and available free of charge at the same address (via the same link) at the end of 5 days following its being made available via this link.

According to a particular embodiment, an information field of the descriptor of item of content C contains a code indicating the coding format of the item of content, such as, for example, MPEG-2, MPEG-4, H.264, WMV, or Quicktime, as a non-restrictive example. According to a variant, the item of content C is available is a plurality of formats and the location of the item of content C in each of the formats is indicated in information fields of the descriptor of the item of content C, received from the broadcast network BDCAST 9.

According to the particular embodiment, the user interface of the receiver-decoder HYSTB 1 does not represent or represents differently a selection object (via the graphic interface, for example), enabling the selection of an item of content by the user, according to whether preconditions exist or not whose necessity is indicated by an item of information (representative of the availability of the item of content) received in an extended EIT table. For example, a pictogram representing an item of paid-for content is not represented by the same colour as a pictogram representing an item of free content, prior to the payment of the prerequisite rights for the restitution of the item of content from the broadband network BDBAND 5.

According to another example, a pictogram representative of an accessible item of content appears with a level of transparency before the time it is made available from the broadband network BDBAND 5 and appears without transparency (more clearly and more visibly) after the time it is made available via the broadband network.

The present disclosure does not only relate to the embodiment described above but further relates to any method in a hybrid reception device, making it possible to access an item of content broadcast over a first network, for example a broadcast network, via the intermediary of a second network, for example a broadband network, prior or subsequent to its broadcast over the first network, and according to an access condition indicated by an item of information received in a table of content descriptor type transmitted over the first network.

The present disclosure also relates to any hybrid audiovisual content reception device, configured for the reception from a first network, for example a unidirectional network of broadcast type, and a second network, for example a bidirectional network of broadband type, implementing the restitution method described.

In particular, the present disclosure relates to a receiver-decoder device adapted to a restitution of an availability of an item of audiovisual content and comprising:
a first communication interface adapted to the reception of at least one item of audiovisual content from a first network, and,
a second communication interface adapted to the reception of at least one item of audiovisual content from a second network.

The receiver-decoder device notably comprises a processor configured for:
a reception, from the first network, of at least one first item of information representative of an availability, via the intermediary of the second network, of at least one item of content broadcast via the first network, the first item of information comprising at least:
   a location of the item of content over the second network;
   a period of availability of the item of content over the second network, different from the period of broadcast of the item of content over the first network;
a restitution, on a user interface of the receiver-decoder device, of at least one second item of information representative of the availability of the item of content via the intermediary of the second network, the second item of information being dependent on the first item of information received.

The present disclosure further relates to any computer program product, comprising program code instructions for executing the steps of the restitution method as described above when the program is executed on a computer.

1. A method for restitution of an availability of at least one item of audiovisual content implemented in a receiver-decoder device comprising:
a first communication interface adapted to the reception of at least one item of audiovisual content from a first network, and
a second communication interface adapted to the reception of at least one item of audiovisual content from a second network,
said method comprising:
a reception, from said first network, of at least one first item of information representative of an availability, via the intermediary of said second network, of at least one item of content broadcast via said first network, said first item of information comprising at least:
a location of said item of content on said second network;
a period of availability of said item of content over said second network, being different from the period of broadcast of said item of content over said first network;
a restitution, on a user interface of said receiver-decoder device, of at least one second item of information representative of said availability of said item of content via the intermediary of said second network, said second item of information being dependent on said first item of information received.

2. The method for restitution of an availability according to claim 1 wherein said first network is a unidirectional broadcast network.

3. The method for restitution of an availability according to claim 1 wherein said second network is a bidirectional communication network.

4. The method for restitution of an availability according to claim 1 wherein said reception is implemented prior and/or subsequent to said broadcast of said item of content by said first network.

5. The method for restitution of an availability according to claim 1 wherein said at least one second item of information comprises at least one object for selection of said item of audiovisual content.

6. The method for restitution of an availability according to claim 1 wherein said method comprises a restitution of all or part of said item of audiovisual content, via the intermediary of said second network.

7. The method for restitution of an availability according to claim 5 wherein said at least one first item of information comprises a precondition, limiting the restitution of said item of content from said second network.

8. The method for restitution of an availability according to claim 7 wherein said restitution of said second representative item of information takes account of said precondition.

9. The method for restitution of an availability according to claim 1, wherein said location comprises at least one link giving access to said item of content on a remote server connected to said second network.

10. The method for restitution of an availability according to claim 1, wherein said at least one first item of information comprises at least one item of information relating to a period of free access to said item of content on said second network with a view to its restitution.

11. The method for restitution of an availability according to claim 1, wherein said at least one first item of information comprises an item of information relating to an association of a related item of content with said item of content, accessible from said second network.

12. The method for restitution of an availability according to claim 1, wherein said at least one first item of information comprises an item of information relating to a cost of access to said item of content via said second network.

13. The method for restitution of an availability according to claim 1, wherein said at least one first item of information representative of the availability of said item of content via the intermediary of said second network comprises an item of information relating to a format and/or a level of quality of restitution of said item of content via the intermediary of said second network.

14. A receiver-decoder device adapted to a restitution of an availability of an item of audiovisual content, said receiver-decoder device comprising:
a first communication interface adapted to the reception of at least one item of audiovisual content from a first network, and,
a second communication interface adapted to the reception of at least one item of audiovisual content from a second network,
said receiver-decoder device comprising a processor configured for:
a reception, from said first network, of at least one first item of information representative of an availability, via the intermediary of said second network, of at least one item of content broadcast via said first network, said first item of information comprising at least:
a location of said item of content on said second network;
a period of availability of said item of content over said second network, different from the period of broadcast of said item of content over said first network;
a restitution, on a user interface of said receiver-decoder device, of at least one second item of information representative of said availability of said item of content via the intermediary of said second network, said second item of information being dependent on said first item of information received.

15. The receiver-decoder device according to claim 14 wherein said at least one first item of information representative of the availability of said item of content via the intermediary of said second network comprises at least one item of information relating to a period of free access to said item of content on said second network with a view to its restitution.

16. A computer program product, comprising program code instructions for executing, when said program is executed on a computer, a method for restitution of an availability of at least one item of audiovisual content implemented in a receiver-decoder device comprising:
a first communication interface adapted to the reception of at least one item of audiovisual content from a first network, and
a second communication interface adapted to the reception of at least one item of audiovisual content from a second network,
said method comprising:
a reception, from said first network, of at least one first item of information representative of an availability, via the intermediary of said second network, of at least one item of content broadcast via said first network, said first item of information comprising at least:
a location of said item of content on said second network;
a period of availability of said item of content over said second network, being different from the period of broadcast of said item of content over said first network;
a restitution, on a user interface of said receiver-decoder device, of at least one second item of information representative of said availability of said item of content via the intermediary of said second network, said second item of information being dependent on said first item of information received.

17. Computer-readable recording medium on which is saved a computer program comprising program code instructions for executing, when said program is executed on a computer, a method for restitution of an availability of at least one item of audiovisual content implemented in a receiver-decoder device comprising:
a first communication interface adapted to the reception of at least one item of audiovisual content from a first network, and
a second communication interface adapted to the reception of at least one item of audiovisual content from a second network,
said method comprising:
a reception, from said first network, of at least one first item of information representative of an availability, via the intermediary of said second network, of at least one item of content broadcast via said first network, said first item of information comprising at least:
a location of said item of content on said second network;
a period of availability of said item of content over said second network, being different from the period of broadcast of said item of content over said first network;
a restitution, on a user interface of said receiver-decoder device, of at least one second item of information representative of said availability of said item of content via the intermediary of said second network, said second item of information being dependent on said first item of information received.
